(19) United States
(12) Patent Application Publication
(10) Pub. No.: US 2005/0170073 A1
(43) Pub. Date: Aug. 4, 2005

(54) Phosphors spray and method for spraying the same

(75) Inventors: Yu-An Li, Taipei (TW); Shih Chien Hsiao, Taipei (TW); Shie Heng Lee, Taipei (TW); Kuei Wen Cheng, Taipei (TW)

Correspondence Address: TROXELL LAW OFFICE PLLC, SUITE 1404, 5205 LEESBURG PIKE, FALLS CHURCH, VA, 22041, US

(73) Assignee: TECO NANOTECH CO., LTD.

(21) Appl. No.: 10/766,812

(22) Filed: Jan. 30, 2004

(51) Int. Cl. B05D 5/12; B05D 5/06; C09K 11/02

(52) U.S. Cl. 427/64; 252/301.36

(57) ABSTRACT

A phosphors spray and a method for spraying the phosphors spray to get a phosphors layer are provided. The phosphors spray and the method are characterized as: 1. A thickness of a phosphors layer can be controlled and adjusted uniformly by a phosphors spraying process. 2. The phosphors layer is thin and easy to manufacture, and further is suitable for a low electrical field or a low voltage within a FED. 3. The phosphors layer has high adhesion abilities to coat on a positive glass substrate or a positive electric layer of the FED, and a low resistance thereof to avoid electric charges accumulating to affect a lighting efficiency of a FED. 4. A solvent of the present invention simplifies the gradients thereof to diminish the costs thereof and practice into commercial use.

### BACKGROUND OF THE INVENTION

1. Field of the Invention

The present invention relates to a technique of coating a phosphor layer on a positive plate of a FED (Field Emission Display), and particularly relates to a technique of coating a phosphor layer on a positive plate of a FED by spaying.

2. Background of the Invention

A FED is a device that utilizes a cathode electron emitter to generate surrounding electrons within an electric field; the electrons excite the phosphors coated on an anode for lighting. The FED is lightweight and thin, and the effect area thereof is variable to meet requirements, but without the view angle problems of flat LCD (Liquid Crystal Display).

FIG. 1 shows a diode FED 1a including a unit 5a with an anode 3a and a cathode 4a disposed therein. The unit 5a includes a rib 53a arranged between the anode 3a and the cathode 4a for separating the anode 3a from the cathode 4a and for supporting therebetween. The anode 3a includes an anode glass substrate 31a, an anode conductive layer 32a, and a phosphors layer 33a arranged sequentially. The cathode 4a includes a cathode glass substrate 41a, a cathode electrical layer 42a, and a cathode electron emitter layer 43a arranged sequentially. The rib 53a connects the anode 3a and the cathode 4a, and a vacuum is formed therebetween. The cathode electron emitter layer 43a generates electrons for emission onto the phosphors layer 33a to produce light via an additional electrical field. The diode FED needs a gap between 50 μm (micrometers) and 200 μm separating the anode 3a from the cathode 4a, a turn-on electrical field under 10 V/μm (Volts per micrometer) or a turn-on voltage above 150 V (volts) to excite the cathode 4a, and the phosphors with a particular efficiency that depends on the materials selected.

The phosphors layer 33a is difficult to light due to the tiny gap and the very small turn-on electrical field. Accordingly, the requirements of structure and a uniform thickness of the phosphorus layer 33a must be met. First, because the gap between the anode 3a and the cathode 4a is restricted for microminiaturization, the thickness of the phosphors layer 33a must be limited, within a range of allowable error, to less than that of the gap, or luminance and uniformity of the FED, which is due to the thickness of the phosphors layer 33a, are reduced. Second, the structure of the phosphors layer 33a means distribution of the phosphors. Although the diode FED needs the turn-on voltage above 150 V, or a triode FED needs a turn-on voltage less than 5000 V, the electrons still provide limited energy, so the phosphors should not have too many stacking layers. With respect to FIG. 2, a first layer of the phosphors 61a excited by an electron beam 1a probably has few redundant electrons to be refracted or diffracted 72a (so called a “secondary energy”), or the first layer of the phosphors 61 with the secondary energy probably does not have energy sufficient to excite inner phosphors 62a. However, the excitation mode is different from that of a CRT (Cathode Ray Tube) adopted for high voltage (23 KV (kilo-volts) at an anode thereof) or a PDP (Plasma Display Panel) adopted for high energy (such as plasma). The CRT provides a panel having a phosphors layer via a spin-coating process, and pattern formed on the phosphors layer via an exposure-and-develop process. The PDP provides a plate with a phosphors layer formed thereon via a screen-printing process. Two methods mentioned above result in different results; first, the spin-coating process makes the coating thickness more uniform than that of the screen-printing process, but includes the phosphors having sizes ranging between 6 μm and 10 μm and the layers of quantity between 3 and 4. So that the coating thickness of the spin-coating process ranges 20 μm and 35 μm, the phosphors thereof is larger than that of the FED. The luminance of the FED will decrease if the phosphors layer is coated by the spin-coating process. Diminishing the coating thickness of the spin-coating process can easily form a pin hole formed in the coating. The FED provides the phosphors layer arranged on an anode glass substrate without additional binder (a conventional process not suited to FED due to an aluminum evaporation coating process thereof), and the FED process requires improvement in the method by which the phosphors is coated on the glass substrate. A second method, the screen-printing process, can provide the phosphors layer with patterns via a paste with a high viscosity above 100,000 cPs (centi-poise). Although the paste uses a particle size of about 4 μm, an aggregate of the paste, between 8 μm and 15 μm, a coating thickness of between 12 μm and 16 μm, and at least three layers of the phosphors, the coating thickness is still large due to the mesh of a screen plate during the screen-printing process, and further, the mesh makes the thickness uneven. The screen-printing process easily forms pin holes in the coating layer if the thickness of the layer is reduced; the FED thus suffers from reduced uniformity and a shadow. Therefore, there are some requirements to be met: how to provide a coating method to improve the uniformity of the FED, how to provide a coating method with minimum phosphors for highest luminance via low electric field or low voltage, and how to provide a simple coating method with cut-off costs for the anode plate of the FED. The present invention provides a phosphors-spraying method to spray the phosphors on the positive plate of the FED, first, to control the thickness thereof evenly, second, to excite the phosphors via the low electric field or the low voltage, and third, to reduce the costs with simple steps and gradient.

Hence, an improvement over the prior art is required to overcome the disadvantages thereof.

### SUMMARY OF INVENTION

According to the conventional methods for the phosphors layers of the FED mentioned above, the coating is difficult to coat evenly, the lighting efficiency thereof decreases due to a large quantity of phosphors layers, the method should be equipped with apparatuses with multiple steps, or the method provides complicated gradients that are expensive. The present invention should conquer the difficulties mentioned above. The present invention provides a phosphors-spraying method for evenly controlling the thickness thereof. The present invention also provides a phosphors-spraying method with an even thickness thereof for a low electric field or a low voltage. The present invention further provides a spray adopted to a phosphors-spraying method to coat the same on an anode glass substrate. The present invention still further provides a spray with phosphors having a conductivity to avoid electric charges accumulating to affect a lighting efficiency thereof. Finally, the present invention provides a spray with simple gradient to reduce costs.

The primary object of the invention is therefore to specify a phosphors-spraying method for evenly controlling thickness thereof.

The secondary object of the invention is therefore to specify a phosphors-spraying method to reduce the amount of phosphors layers and to increase denseness ability between the phosphors to improve the lighting efficiency.

The third object of the invention is therefore to specify a phosphors spray adopted to a phosphors-spraying method with improved adhesion abilities to coat the same on an anode glass substrate or a positive electric layer.

The fourth object of the invention is therefore to specify a phosphors spray adopted to a phosphors-spraying method to reduce a resistance of phosphors layers and avoid electric charges accumulating to affect a lighting efficiency of a FED.

The fifth object of the invention is therefore to specify a phosphors spray adopted to a phosphors-spraying method to reduce manufacturing and material costs for business applications.

According to the invention, this object is achieved by a method for spraying a phosphors spray to get a phosphors layer. A proper and vaporizable solvent is selected to disperse and suspend the phosphors scattered therein. The phosphors is mixed with a binder, an electrical powder and a surfactant to be the spray with a low viscosity. The mixed solvent is carried by pressurized air to spray uniformly on a positive conductive layer or a positive glass substrate. A thickness of a film sprayed by the mixed solvent can be adjusted and controlled by a spraying frequency thereof to control evenly and uniformly the thickness thereof in the spraying. The mixed solvent then vaporizes rapidly to expose the phosphors on a surface of the film, and by means of pressurized air, particles of phosphors can be evenly sprayed on the anode conductive layer or the anode glass substrate to improve adhesion abilities thereof, the phosphors layer can be triggered via a low electric field or a low voltage thereby for improving the lighting efficiency of a FED.

The present invention provides a gradient of the phosphors spray including a plurality of phosphors, a solvent vaporizing within a range between predetermined temperatures to suspend the phosphors scattered therein, a binder mixed in the solvent and having a predetermined adhesive characteristic with predetermined interfaces after a predetermined adhesive process to be adherent between the phosphors and a surface of the anode of the electronic device. The solvent with the phosphors is sprayed on the surface of the anode of the electronic device repeatedly, the solvent then vaporizes within the range between the predetermined temperatures, and after the predetermined adhesive process, the phosphors are further dispersed and adhered onto the surface of the anode of the electronic device.

The present invention provides a method for spraying a phosphors spray including steps of: (1) spraying the phosphors spray on the surface of the anode of the electronic device; (2) vaporizing the solvent within the range between the predetermined temperatures; and (3) repeating steps (1) and (2) a predetermined number of times to provide a film having a thickness within a predetermined range.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a conventional FED;

FIG. 2 is a perspective view of a phosphors layer via a screen-printing process; and

FIG. 3 is a perspective view of a phosphors layer via a spraying method according to the present invention.

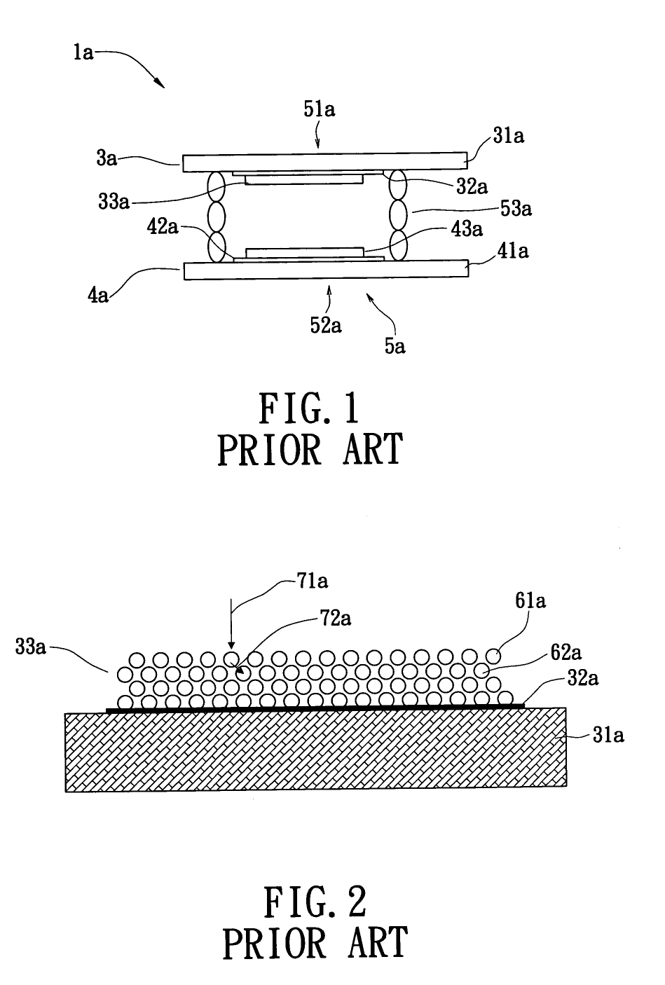

### DETAILED DESCRIPTION OF THE EMBODIMENTS

The present invention provides a method for spraying a phosphors spray to obtain a phosphors layer. A proper and vaporizable solvent is selected to disperse and suspend the phosphors scattered therein. The phosphors is mixed with a binder, an electrical powder, or a surfactant to be the phosphors spray with a low viscosity. The mixed solvent is propelled by a pressurized air to be sprayed uniformly on an anode conductive layer or an anode glass substrate. A thickness of the film sprayed by the mixed solvent can be adjusted and controlled by a spraying frequency thereof to control evenly and uniformly the thickness thereof in the spraying. The mixed solvent then vaporizes rapidly to expose the phosphors on a surface of the film, and according to the pressurized air, particles of phosphors can be evenly sprayed on the anode conductive layer or the anode glass substrate to improve adhesion abilities thereof. The phosphors layer can be triggered via a low electric field or a low voltage thereby for improving the lighting efficiency of a FED, thus quantity of the phosphors layers can be decreased.

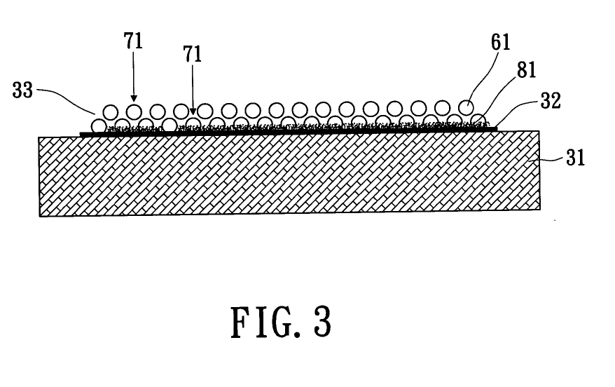

FIG. 3, illustrates a perspective view of the phosphors layer formed by spraying according to the present invention. Particles 81 of smaller phosphors, the binder, and the electrical powder fill the gaps formed between particles 61 of larger phosphors. The phosphors spray with the low viscosity deposits particles 81 on a surface of the glass substrate or the conductive layer to compact the phosphors 61 and 81 with at least one or two coating layers, and the luminance thereof improves thereby.

The present invention provides a phosphors layer coated on an anode of a FED. A spray gun filled with pressurized air is provided to vaporize the phosphors spray for spraying the phosphors spray onto a surface of the anode conductive layer or the anode glass substrate. For mating with the solvent and a solid content thereof, the spray gun includes a pressurized air valve having a flow rate of at least 160 liters per minute (1/min). The solvent includes a material of Isoamyl Actrate. After adding the needed binder into the solvent, and sintering to vaporize the solvent, the phosphors are adhered onto the anode conductive layer or the anode glass substrate. The binder can include materials of glass powder or collodion. Phosphors with semi-conductive materials, such as zinc sulfide (ZnS) or yttrium oxide (Y₂O₃) are selected. In addition, the electrical powder includes silver, saline with indium, or indium-doped zinc oxide (IZO) to reduce impedance of the surface of the anode of the electronic device and to avoid electric charges accumulating to affect a lighting efficiency thereof. Furthermore, a surfactant is added to disperse uniformly the phosphors and the powders scattered in the Isoamyl Actrate solvent. The solvent has a viscosity between 10 and 20 centi poise (cPs), and particularly between 12 and 18 centi poise (cPs). The particles of the binder, the binder or the electrical powder must be controlled so that the thickness of the coating layer is uniform as for a FED with a low electric field or a low voltage. Each phosphors particle has a particle size less than 1.0 micrometer (μm), while the electrical powder and the binder have a particle size under 0.2 micrometer (μm).

Subsequently, the phosphors spray is sprayed and dispersed by a spray gun with the pressurized air. The pressurized air carries a plurality of suspended solids 61 in the solvent, such as the phosphors, the binder, and the electrical powders, which are coated onto a surface of the anode. Because the phosphors has specific weight heavier than that of other particles, the glass powder, the binder, the silver, and the electrical powders, the smaller phosphors, the binder, and the electrical powders fill the gaps formed between particles 61 of larger phosphors or surround a periphery of each particle 61 of larger phosphors. The phosphors spray with the low viscosity provides the particles 81 deposited on a surface of the glass substrate or the conductive layer with the phosphors 61 and 81 coated and compacted after the sintering process to reduce an impendence and increase a dielectric constant between the phosphors and the glass substrate. The phosphors spray with the low viscosity coats the surface of the glass substrate via the pressurized air. The phosphors is naturally deposited in a stable manner with a stable structure, and the thickness thereof can be decreased by at least one or two coating layers to meet the requirements of the low electric field or the low voltage of the FED thereby.

According to a preferred embodiment of the present invention, the phosphors spray is made of Isoamyl Actrate materials. In particular, the phosphors spray adds a binder, which is made of glass and has a weight percentage of between 10 and 15 with an average particle size under 0.3 micrometers (μm). The phosphors spray further adds electrical powders having silver, saline with indium, or indium-doped zinc oxide (IZO) materials. Each of the silver, saline with indium, or indium-doped zinc oxide (IZO) has a weight percentage of between 15 and 25 with an average particle size under 1.0 micrometer (μm) to increase a conductivity of the phosphors layer. Furthermore, the phosphors spray additionally adds surfactant scattered therein, and has a viscosity of between 15 and 18 centi poise (cPs). The phosphors spray is applied with the commercial spray gun with a nozzle having a diameter of 1.0 millimeters (mm), a pressurized air valve having a flow rate of 260 liters per minute (1/min), and an adjustable solvent valve having a solvent flow rate controlled of 200 cubic centimeters per minute (cc/min). Accordingly, the phosphors is dispersed on the anode conductive layer or the anode glass substrate with the phosphors spray to get make the phosphors layer, and then the anode glass substrate is sintered to combine the phosphors layer on the anode conductive layer at a temperature of 400 degrees Celsius.

Thus, the phosphors includes materials of P-22 ZnS: Cu, Al. The ZnS represents zinc sulfide, the Cu represents copper, and the Al represents aluminum. The present invention includes particle sizes of phosphors of between 1.0 and 0.8 micrometer (μm) and provides a phosphors layer with a thickness between 1.5 and 2.5 micrometers (μm), which is much less than that of phosphors layer of 10 micrometers (μm) made via the screen-printing process. The phosphors layer of the present invention has a tolerance under 1.0 micrometer (μm), and this provides a high luminance thereof. In comparison to the present FED made via the spraying method, the conventional FED via the spin-coating process provides a paste including a polyvinyl alcohol (PVA) with phosphors of P-22 ZnS: Cu, Al formed on a positive plate. If both the FED according to the present invention and the conventional FED are examined by Scotch tape for adhesion testing and investigating with a UV lamp, above 95% of the phosphors layer peels off the conventional FED, but only 1% of the phosphors layer provided by the FED of the present invention peels off. Furthermore, the present FED has a high luminance of 600 nits (cd/m2, candlelight per meter square) via an electrical field of 4 volts per micrometer (V/μm). Additionally, the present FED adopted for the spraying method can coat a large area on the positive plate easily.

Referring to FIG. 3, the present invention provides a gradient of the phosphors spray including a plurality of phosphors particles, a solvent vaporizing within a range of the predetermined temperatures to suspend the phosphors scattered therein, a binder in the solvent, and a predetermined adhesive characteristic with predetermined interfaces after a predetermined adhesive process to provide adhesion between the phosphors 62 and a surface of the anode of the electronic device. The solvent with the phosphors is sprayed on the surface of the anode of the electronic device repeatedly, the solvent then vaporizes at the predetermined temperatures, and, after the predetermined adhesive process, the phosphors particles are dispersed and adhered onto the surface of the anode of the electronic device. The present invention provides the phosphors layer 33 on the positive plate 31 of the anode conductive player 32 and emits an electron beam 71. After the phosphors particles are spray coated on the positive plate of the electronic device processes the sintering process.

The phosphors spray further includes an electrical powder capable of reducing impedance of the surface of the anode of the electronic device, and furthermore a surfactant to disperse the electrical powders, the binder and the phosphors uniformly in the phosphors spray. The electrical powders include silver, saline with indium, or indium-doped zinc oxide (IZO). The binder includes glass powder or collodion. The solvent includes Isoamyl Actrate. The phosphors spray has a viscosity of between 15 and 20 centi poise (cPs), and after the predetermined adhesive process including a sintering process or a laser heating process, the coating layer becomes the phosphors layer 33 formed thereon.

In FIG. 3, the present invention provides a method for spraying a phosphors spray including steps of: (1) spraying the phosphors spray on the surface of the cathode of the electronic device; (2) vaporizing the solvent within the range of predetermined temperatures; and (3) repeating steps (1) and (2) a predetermined number of times to obtain a film having a thickness within a predetermined range. The method further includes a step after the step (3), providing a predetermined adhesive process to obtain the phosphors layer 33. The predetermined adhesive process includes a sintering process or a laser heating process. The phosphors spray is applied with a commercial spray gun. The commercial spray gun includes a nozzle having a diameter of between 0.5 and 2.0 millimeters (1/min), a pressurized air valve having a flow rate of between 240 and 280 liters per minute (1/min), and an adjustable solvent valve having a solvent flow rate of between 150 and 250 cubic centimeters per minute (cc /min). Each phosphors particles has a particle size less than 1.0 micrometer (μm), so that the phosphors layer 33 has a thickness of between 1.5 and 2.5 micrometers (μm).

The present invention is characterized by:

1. The thickness of the phosphors layer 33 can be controlled and adjusted uniformly by the phosphors spraying process.

2. The phosphors layer is thin and easy to manufacture, and further suitable for a low electrical field (under 5 Volts per micrometer (V/μm)) or a low voltage (under 300 volts (V)) within the FED.

3. The solvent of the present invention simplifies the gradients thereof to diminish the costs thereof and practice in commercial use.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A phosphors spray adopted for an anode of an electronic device, comprising:
a plurality of phosphors particles;
a solvent vaporizing within a range of predetermined temperatures to suspend the phosphors particles scattered therein; and
a binder in the solvent, the binder possessing a predetermined adhesive characteristic with predetermined interfaces after a predetermined adhesive process to be adhesive between each of the phosphors particles and a surface of the anode of the electronic device;
whereby the solvent with the phosphors particles is sprayed on the surface of the anode of the electronic device repeatedly, the solvent then vaporizes within the range of the predetermined temperatures, and, after the predetermined adhesive process, the phosphors particles are dispersed and adhered onto the surface of the anode of the electronic device.

2. The phosphors spray claimed as claim 1, further including an electrical powder having a characteristic of reducing impedance of the surface of the anode of the electronic device.

3. The phosphors spray claimed as claim 2, further including a surfactant dispersed therein and further uniformly dispersing the binder and the phosphors particles.

4. The phosphors spray claimed as claim 3, further including a viscosity of between about 10 and 20 centi poise (cPs), wherein the electrical powder includes silver, saline with indium, or indium-doped zinc oxide (IZO), the binder includes glass powder or collodion, and the solvent includes Isoamyl Actrate.

5. The phosphors spray claimed as claim 1, wherein the predetermined adhesive process includes a sintering process or a laser heating process.

6. A method for spraying a phosphors spray claimed as claim 1, comprising:
(1) spraying the phosphors spray on the surface of the anode of the electronic device;
(2) vaporizing the solvent within the range of predetermined temperatures; and
(3) repeating steps (1) and (2) a predetermined number of times to obtain a film having a thickness within a predetermined range.

7. The method claimed as claim 6, further including after the step (3) a step of providing a predetermined adhesive process to obtain a phosphors layer.

8. The method claimed as claim 7, wherein the predetermined adhesive process includes a sintering process or a laser heating process.

9. The method claimed as claim 6, wherein the phosphors spray is applied by a commercial spray gun, and the commercial spray gun includes a nozzle having a diameter of between about 0.5 and 2.0 millimeters (mm), a pressurized air valve having a flow rate of between about 240 and 280 liters per minute (1/min), and an adjustable solvent valve having a solvent flow rate of between about 150 and 250 cubic centimeters per minute (cc/min).

10. The method claimed as claim 7, wherein each phosphors particle has a particle size of less than about 1.0 micrometer (μm), the electrical powder and the binder have a particle size of less than about 0.2 micrometer (μm), respectively, and the phosphors layer coated on the anode has a thickness of between about 1.5 and 2.5 micrometers (μm).
